(19) United States
(12) Patent Application Publication
(10) Pub. No.: US 2002/0133522 A1
(43) Pub. Date: Sep. 19, 2002

(54) Apparatus for facilitating access to information

(76) Inventors: Laurence Raymond Greetham, Berkshire (GB); Jonathan David Carroll, Berkshire (GB); Richard Edwards, Berkshire (GB)

Correspondence Address: FINNEGAN, HENDERSON, FARABOW, GARRETT &, DUNNER LLP, 1300 I STREET, NW, WASHINGTON, DC, 20005, US

(21) Appl. No.: 09/851,374

(22) Filed: May 9, 2001

(30) Foreign Application Priority Data
Mar. 19, 2001 (GB) 0106781.8

(51) Int. Cl. G06F 17/21

(52) U.S. Cl. 707/534; 707/532

(57) ABSTRACT

The apparatus has a user interface (16) having a keyboard (17) for enabling a user to input information, a display (15) for displaying information to the user, a data store (28) for storing keywords and a processor (10) having associated memory (11). The processor (10) is configured by program instructions to provide an information alerter that has an icon displayer (30) for displaying an information alerter icon on top of an applications window displayed on the display (15); a keystroke receiver (26) for receiving keystroke information relating to keystrokes made by the user to input information into an applications window displayed by the displayed by the display (15); a keyword comparer (27) for comparing keywords stored in the data store (28) with keystroke information received by the keystroke receiver; and a user alerter (310 for causing at least a part of the alerter icon to change when the keyword comparer (27) identifies at least one keyword corresponding to information input to an application as keystrokes by the user.

This invention relates to apparatus for facilitating access to information, in particular, but not exclusively, to a user interface for alerting a user of a computer to the existence of information.

Conventional computer systems enable a user to seek out, access and display or print out information. Such systems may enable a user to retrieve information from a local database or to search out information on, for example, the Internet using a web browser and a search engine. In each case, however, a positive decision is required by the user to seek out information.

In one aspect, the present invention provides information providing apparatus that alerts a user to the existence of information relevant to information input to the apparatus by the user.

In one aspect, the present invention provides information providing apparatus for alerting a user to the existence of information relevant to keywords input by a user using a user interface such as a keyboard.

In one aspect, the present invention provides a computer user interface that enables a user to be alerted to the existence of information relevant to their current activity.

In one aspect, the present invention provides information providing apparatus that enables a user to be alerted to the existence of a number of different types of information.

In one aspect, the present invention provides information providing apparatus that alerts a user to the existence of information relevant to their use of the apparatus and, in response to a request from the user, connects the use to a source of that relevant information.

In one aspect, the present invention provides a user interface that alerts a user to the existence of information relevant to keywords input by the user into an application being run on a computer.

Embodiments of the present invention will now be described, by way of example, with reference to the accompanying drawings, in which:

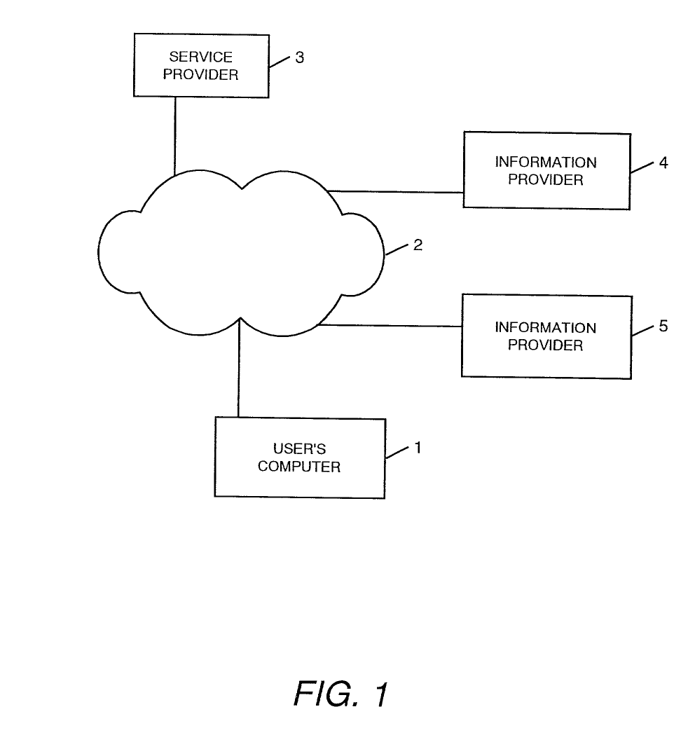

FIG. 1 shows a very schematic diagram of a computer network;

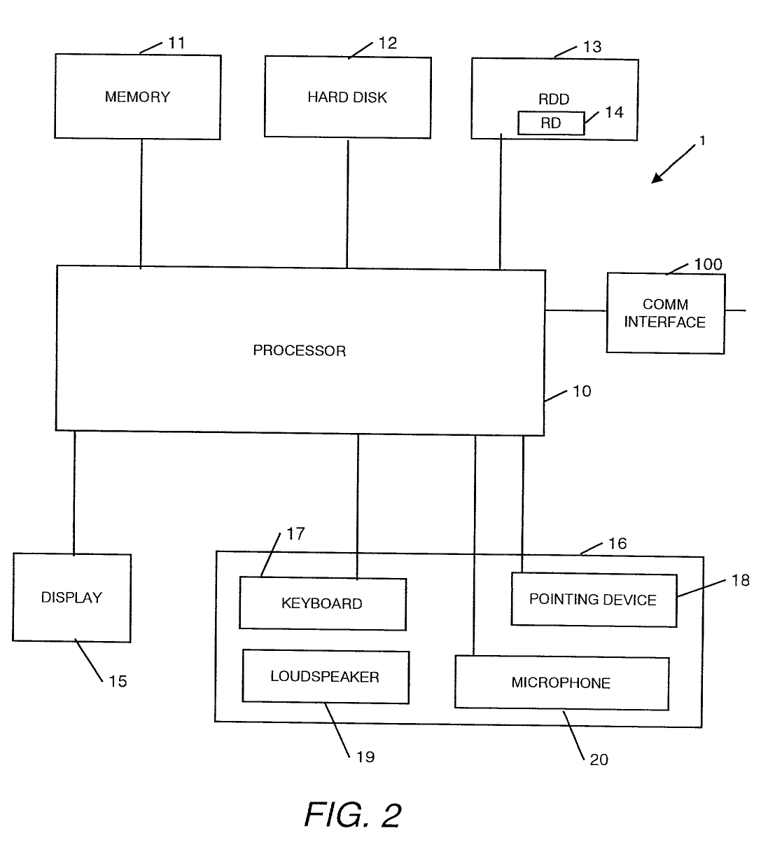

FIG. 2 shows a block diagram of a computer;

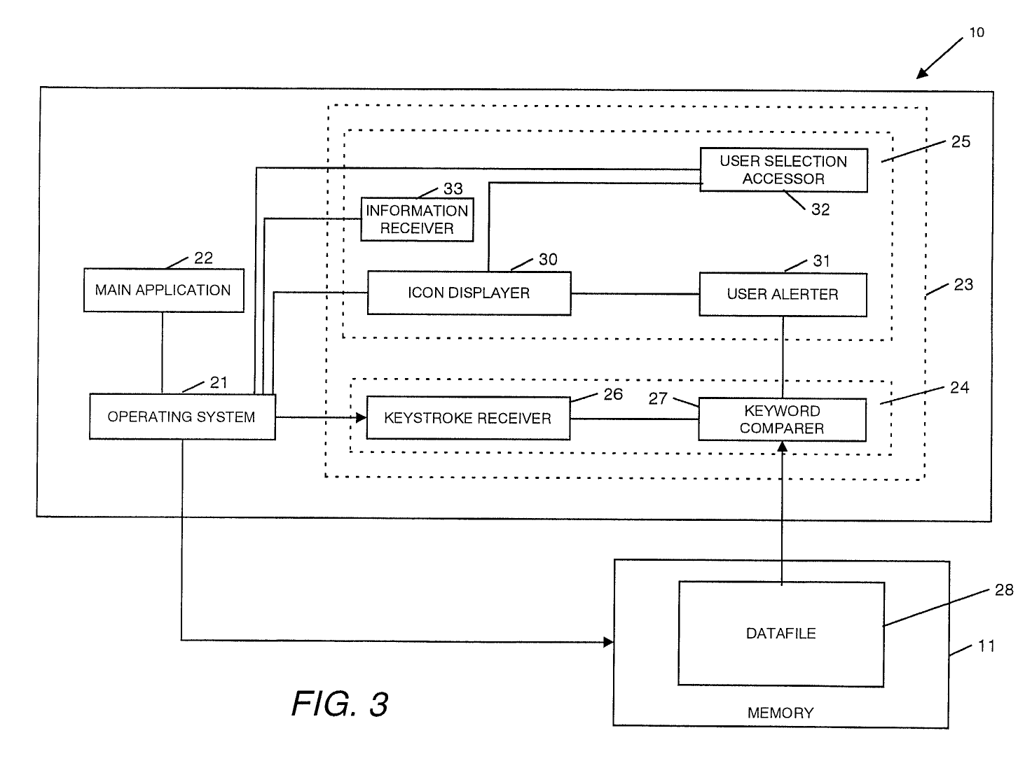

FIG. 3 shows a functional block diagram illustrating the functional components provided by a processor of a computer shown in FIG. 2 when programmed to carry out a method embodying the present invention;

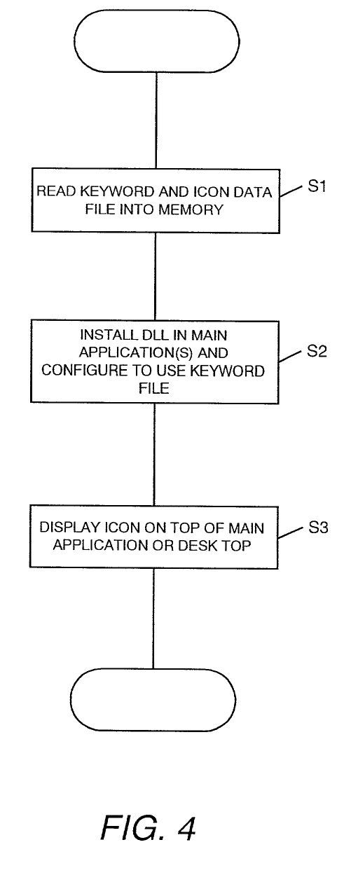

FIG. 4 shows a flow chart for illustrating installation of software or program instructions embodying the invention into the processor of the computer shown in FIG. 2;

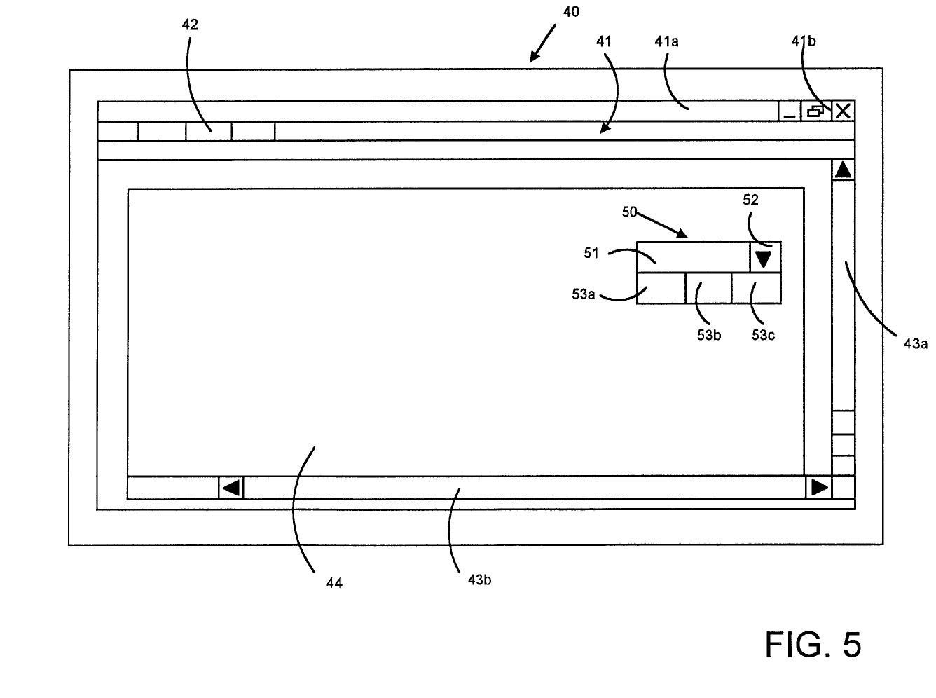

FIG. 5 shows an example of a display screen shown by the display of the computer shown in FIG. 2;

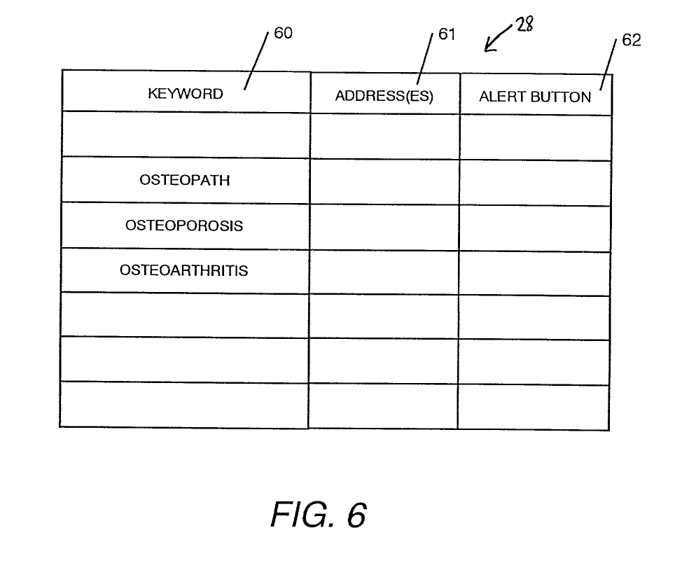

FIG. 6 shows very schematically part of a keyword data file stored by the computer shown in FIG. 2;

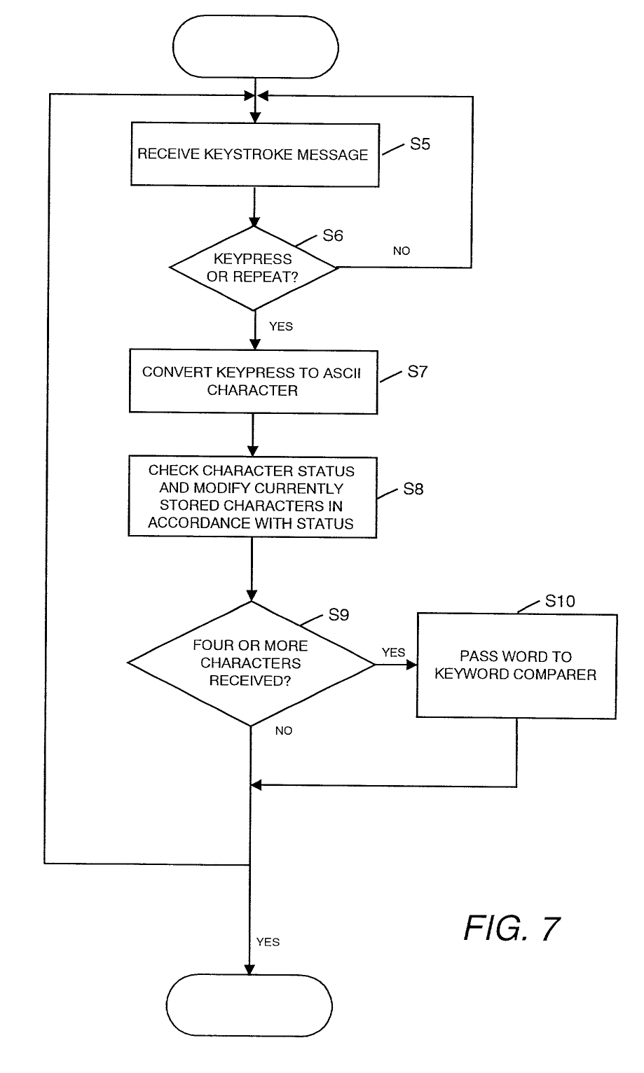

FIG. 7 shows a flow chart for illustrating steps carried out by a keystroke receiver shown in FIG. 3;

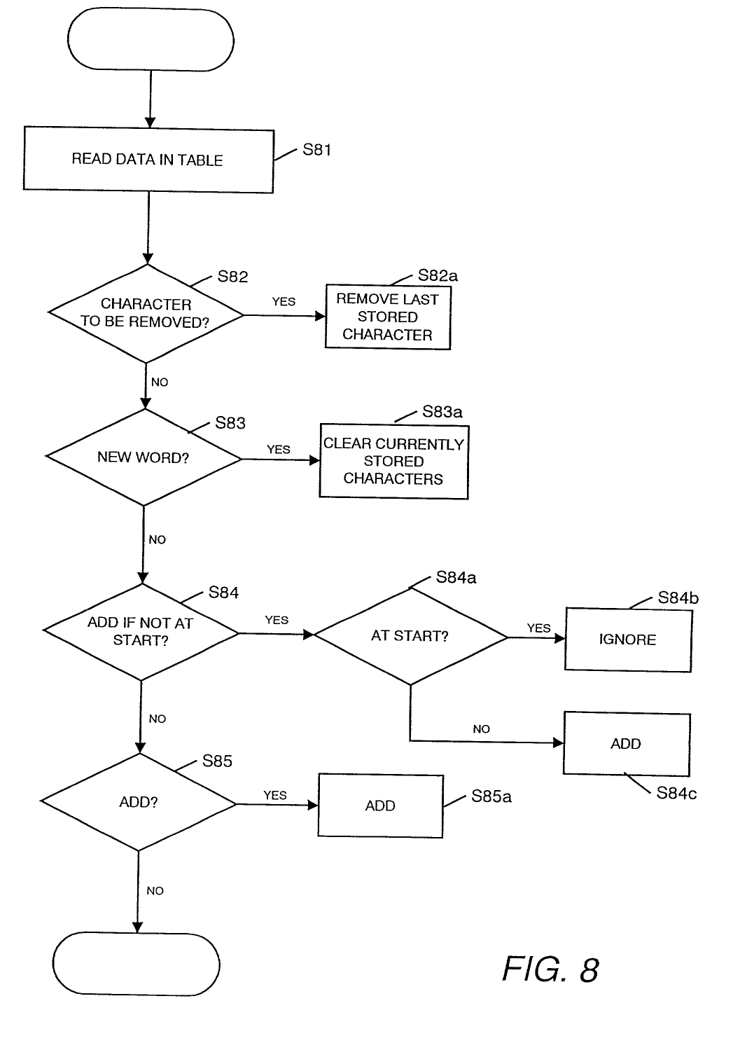

FIG. 8 shows a flow chart illustrating in greater detail a step of checking character status shown in FIG. 7;

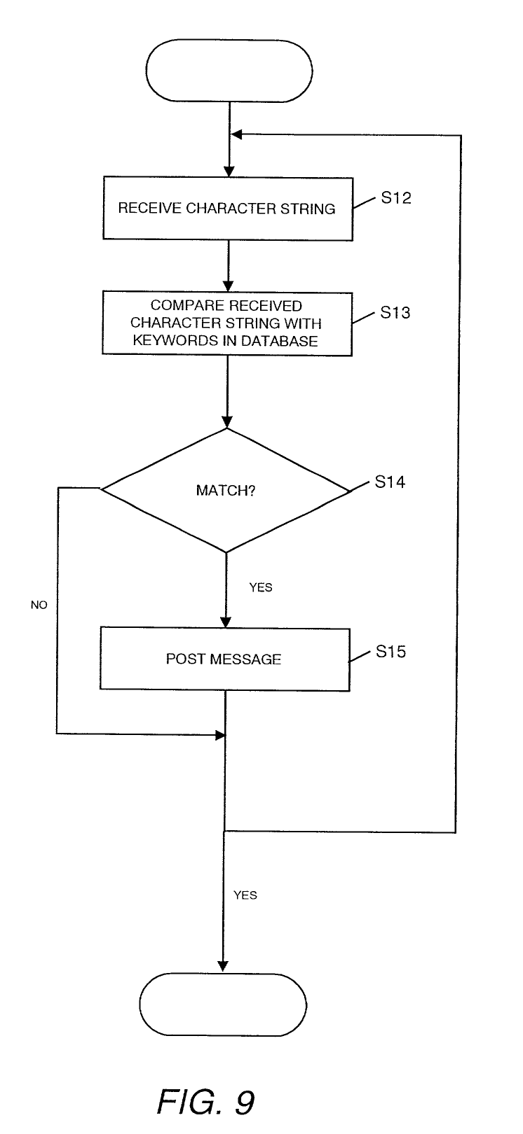

FIG. 9 shows a flow chart for illustrating steps carried out by a keystroke comparator shown in FIG. 3;

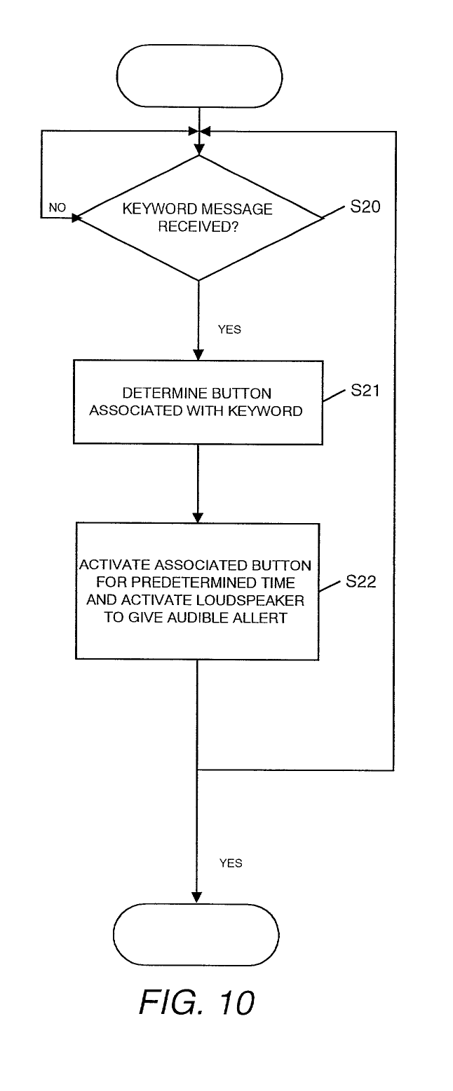

FIG. 10 shows a flow chart for illustrating steps carried out by a user alerter shown in FIG. 3;

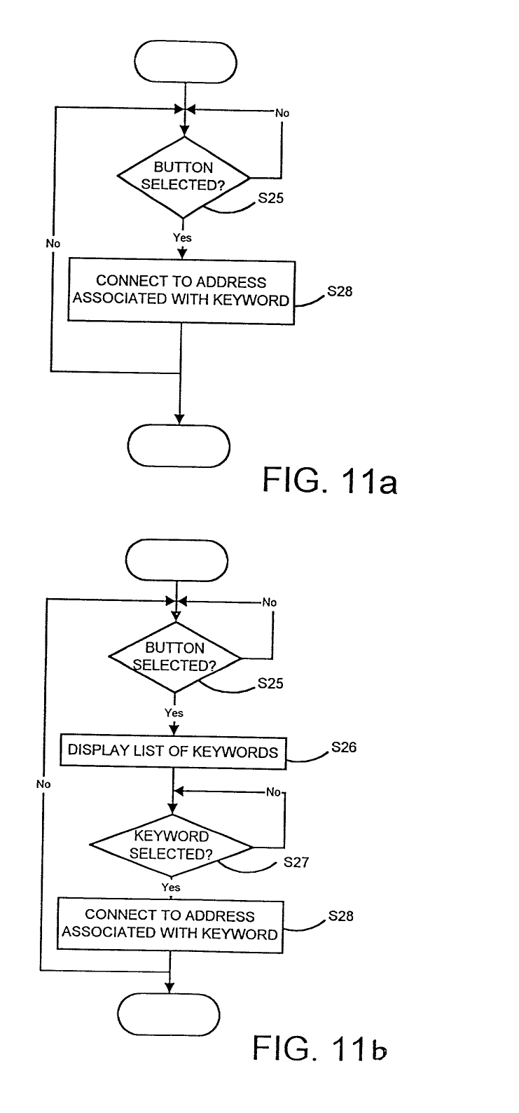

FIG. 11a shows a flow chart for illustrating steps carried out by a user selection accessor shown in FIG. 3;

FIG. 11b shows a modified version of the flow chart shown in FIG. 11a; and

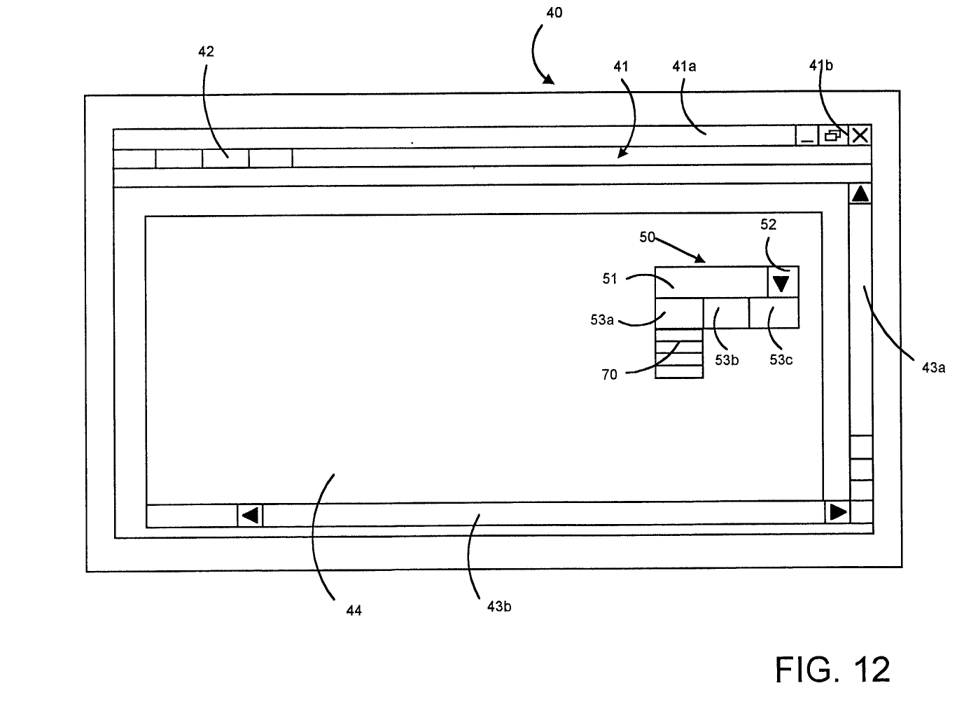

FIG. 12 shows a display screen that may be displayed to a user on the display 15.

Referring now to the drawings, FIG. 1 shows a user's computer 1 coupled via a network 2 to a service provider 3. As shown in FIG. 1, the user's computer 1 is also coupled via the network 2 to information providers 4 and 5. In this embodiment, the network 2 comprises the Internet and the service provider 3 functions as the Internet service provider (ISP) for the user's computer 1.

In this embodiment, the user's computer 1 operates under the Windows operating system and the server 3 uses the Intel/Microsoft NT operating system.

The service provider 3 provides or enables access to one or more databases each of which may be directed towards a specific subject matter area. For example, the service provider 3 may store one or more databases consisting of medical information such as, for example, the Clinnix database which is a medical database currently provided for healthcare professionals by the applicants. The information provider 4 may, in the United Kingdom, represent the NHSnet which provides a database of medical information for general practitioners and healthcare professionals within the NHS (National Health Service). The other information provider 5 may, for example, provide a database maintained by a commercial company involved in the medical field, for example a pharmaceutical company.

Typically, as shown in FIG. 2, the user's computer 1 consists of a central processor 10 having associated memory (ROM and/or RAM) 11, a hard disk 12, a removable disk drive (RDD) 13 for receiving a removable disk (RD) 14 such as, for example, a floppy disk drive for receiving a floppy disk or a CD ROM or DVD drive for receiving a CD ROM or DVD disc. The computer 1 also has a display 15, for example a CRT or LCD display, a communications interface 100 such as a MODEM for enabling connection to the network 2 and a user interface 16 for enabling a user to communicate with the processor. As shown in FIG. 2, the user interface 16 consists of a keyboard 17, a pointing device 18 such as a mouse and optionally a loudspeaker 19 and microphone 20.

FIG. 3 shows a functional block diagram of the processor 10 and memory 11 of the computer shown in FIG. 2 when configured by program instructions to provide information processing apparatus.

As shown in FIG. 3, the processor 10 is configured by program instructions to provide an operating system 21 which, in this example, is a Microsoft Windows (Registered Trade Mark) operating system and one or more main applications 22. These main applications will generally be commercially available software packages such as word processing packages (for example, Microsoft Word or WordPerfect), databases (such as Microsoft Access), spreadsheets (such as Quattro-Pro or Microsoft Excel) and so on.

The processor 10 is also configured to provide an information alerter 23 embodying the invention consisting of a keyword identifier 24 and a user interface provider 25. The keyword identifier comprises a keystroke receiver 26 that receives information relating to keystrokes made by the user on the keyboard 17 to identify words input by the user and a keyword comparer 27 that compares words identified by the keystroke receiver 26 with keywords stored in a data file 28 in the memory 11 of the computer.

The user interface provider 25 comprises an icon displayer 30 which causes, via a display driver (not shown separately) of the operating system 21, an information alerter icon to be displayed on the display screen of the display 15 so that the information alerter icon is always on top of the desktop or any application window open in Windows. The user interface provider 25 also includes a user alerter 31 that, in response to a signal indicating a keyword match from the keyword comparer 27, controls the icon displayer 30 to cause a change in the displayed icon to alert the user to the existence of relevant information. The user interface provider 25 also has a user selection accessor 32 that, as will be explained in greater detail below, in response to a user clicking on or selecting a button or part of the information alerter icon causes, via communication software of the operating system 21 and the communication interface 100, information to be downloaded to an information receiver 33 and displayed on the display 15.

As is well known in the art, the Microsoft Windows operating system is a message based architecture in which, as the user presses and releases keys, the keyboard driver (not shown separately in the drawings) of the operating system 21 passes keystrokes to the Windows operating system 21 which saves the keystrokes in the form of messages, in a system message queue. The keyboard messages are then transferred one message at a time to the message queue of the application or program that contains the current input focus which is either the currently active window or a child window of the active window.

The Microsoft Windows operating system provides hooks which are points in the system message handling mechanism at which applications can install sub-routines to monitor the progress of message traffic in the system.

In the present embodiment, the information alerter 23 is provided by two software components, one of which provides the keyword identifier 24 and consists of a system level keyboard hook procedure and a dynamic link library (DLL) and the other software component is an alerter main application or executable that is launched by the user upon start up of the computer.

The keyboard hook procedure forces the operating system 21 to call the alerter dynamic link library whenever any key is pressed or released. The dynamic library then carries out the functions of the keystroke receiver 26 and keyword comparer 27 as will be described in detail below. Because the keyboard hook procedure operates at system level, it is effective for any main application(s) 22 that may be run by the computer so that the keystroke receiver 26 receives keystroke messages whenever a user presses or releases a key.

The alerter main application is responsible for installing and managing the keyboard hook and provides the functional elements of the user interface provider 25.

The program instructions or software for providing the information alerter 23 may be downloaded by the processor 10 from a removable disk 14 received in the removable disk disk drive 13 or may be downloaded as a signal S supplied via the communications interface 100 from another computer (not shown) coupled to the network 2, for example the service provider 3.

The main application is launched whenever the user starts up the Windows operating system 21. FIG. 4 shows a flow chart for illustrating the basic steps carried out when the main application is launched by the user. Thus, at step S1, the main application reads keyword and icon data files into the memory 11 from the hard disk drive 12. Then, at step S2, the alerter dynamic link library is installed in any main application that is running and configured to use the keyword file stored in the memory 11 and at step S3, the information alerter icon is displayed on top of the current main application 22 or the desk top if no main application is currently running.

As will be appreciated, the alerter dynamic link library will be installed in any main application that is installed or started up, as and when that main application is launched.

FIG. 5 shows an example of a display screen 40 that may be displayed by the display 15.

The display screen 40 is shown displaying the currently active window 41 of a main application. This window 41 has, as is well known in the art, a title bar 41a window, resizing and closing buttons 41b, a number of drop down menus 42, a user work area window 44 and scroll bars 43a and 43b for enabling a user to scroll the work area window 44 up and down and left and right, respectively. Other conventional features of the window 41 have been omitted in the interest of simplicity.

The main application 22 may be, as mentioned above, any commercially available wordprocessing, spreadsheet, database or graphics package and, of course, the functions provided by the drop down menus will depend upon the particular application.

FIG. 5 shows an information alerter icon 50 provided by the information alerter 23. This icon consists of a button 51 which provides a title bar and can also display information from information providers to the user, a drop down arrow 52 for enabling a user to select a drop down list of movies or videos and alert buttons, in this example, three alert buttons 53a to 53c. The information alerter icon 50 may be positioned by the user at any desired location within the window 41 or on the display screen 40 by dragging and dropping the icon 50 in conventional manner. The icon 50 may also be resized or reshaped in conventional manner.

The three alert buttons 53a, 53b and 53c are of different colour. In this embodiment, the three alert buttons are coloured red, amber and green and are provided to alert the user to commercially provided relevant information, the user's own prestored information and non-commercial, for example, academic information, respectively. In the system shown in FIG. 1, information available from the information provider 4 will be classified as academic information while information available from the information provider 5 will be classified as commercial information.

The keyword data file may be an initial keyword file provided with the information alerter 23 or may be a subsequently updated keyword data file. Updating of the keyword data file may be effected periodically by the server 3. The keyword data file will generally have a personal section that enables a user to add keywords to the keyword data file.

FIG. 6 shows part of a keyword data file. The keyword data file consists of a list of keywords 60 each associated with one or more addresses 61 and information 62 identifying the corresponding alert button 53a, 53b, 53c. An address may be a URL (universal resource locator) identifying a location on the Internet at which information related to that keyword can be located or a local address in the form of a file name on the user's own computer or a local file server coupled to the user's computer in a local network. FIG. 6 shows three possible keyword entries (osteopath, osteoporosis, osteoarthritis) for a medical keyword data file. The entries in the data file may be in any order and are sorted alphabetically using a conventional sorting routine when the data file is loaded at step SI in FIG. 4.

Operation of the information alerter 23 will now be described with reference to FIGS. 7 to 13 for the case where the main application being run by the user is a word processing package and the user is typing a document such as a letter or filenote in the work area window 44.

Referring first to FIG. 7, as the user presses and releases keys on the keyboard 17, the keystroke messages provided by the keyboard driver of the operating system 21 are passed to the main application in the normal manner and are also passed by the keyboard hook procedure to the alerter dynamic link library. The keystroke receiver 26 provided by the alerter dynamic link library thus receives a keystroke message at step S5 in FIG. 7. As is well known in the art, the keystroke message identifies whether the keystroke is a keypress or release and also provides data identifying the particular key which was pressed or released.

The keystroke receiver 26 then checks at step S6 whether the received keystroke is a key press or repeat. If the answer is no, then the received keystroke is ignored. The keystroke receiver 26 thus filters out key releases and irrelevant keystrokes and accepts only key presses and repeat keystrokes. Key releases are filtered out to ensure that each key actuated by the user is counted only once (that is upon depression and not upon subsequent release). The irrelevant keystrokes that are filtered out are keystrokes where the user is pressing or releasing control keys such as “ALT”, “CONTROL”, “SHIFT” and the function keys. The keystroke receiver 26 thus ignores keystrokes which could not possibly form part of a word.

When the answer at step S6 is yes, then at step S7 the keystroke receiver 26 converts the keypress to an ASCII character and then at step S8 checks the status of that character and modifies any currently stored characters in accordance with the character status.

The keystroke receiver 26 checks the character status by accessing a table stored in memory 11. This table lists against each ASCII character an action that should be taken by the keystroke receiver 26 in response to receipt of that character.

FIG. 8 shows a flow chart illustrating step S8 in greater detail. At step S81, the keystroke receiver 26 reads from the table the action that it should take in response to receipt of that character.

If, at step S82, the action associated with the character is “remove” then at step S82a the keystroke receiver 26 removes the last stored character, if a character has previously been stored. Generally, the “remove” action will be associated with the backspace character and any other key that functions to delete the last character.

If, at step S83, the action associated with the received character is “new”, then the keystroke receiver 26 clears the currently stored characters at step S83a. The action “new” is associated with keys that represent the start of a new word (for example the return key and space bar) and also with the navigational keys or arrows because these cause a repositioning of the Windows caret.

If, at step S84, the action is “add if not start” then the keystroke receiver 26 checks at step S84a whether the character is at the start of a word (that is whether there are no characters currently stored) and if the answer is yes ignores that character at step S84b. If, however, the answer is no, then at step S84c, the keystroke receiver 26 adds that character to the stored characters. An example of a character associated with the “add if not start” action is a single-quote or apostrophe which may form part of a word, for example a word such as the name D'Arcy.

If, at step S85, the keystroke receiver 26 determines that the action associated with the received character is “add” then at step S85a it adds that character to the stored characters. Any none ASCII characters received will not be present in the table and are simply ignored.

The keystroke receiver 26 then checks at step S9 whether it has received a predetermined number of characters, in this case four or more characters. If the answer is yes, then the keystroke receiver 26 passes the character string as a word to the keyword comparer 27 at step S10. If the answer at step S9 is no, the keystroke/receiver 26 returns to step S5. Steps S5 to S11 in FIG. 7 will thus be repeated continually while the user is in the main application with the received characters being passed to the keyword comparer 27 at step S10 every time four or more characters have been received and stored. As the alerter DLL is loaded into any main application that is running, each such main application will have its own keystroke receiver 26 and keyword comparer 27 which operate independently so that a user can switch back and forth between main applications each of which has its own keystroke receiver and keyword comparator.

FIG. 9 shows a flow chart illustrating steps carried out by the keyword comparer 27. Thus, at step S12, the keyword comparer 27 receives a four or more character string or word from the keystroke receiver 26. Then at step S13, the keyword comparer 27 compares the received character string with keywords stored in the data file 28. In this embodiment, the keyword comparer 27 uses a conventional binary chopping search routine, which, in combination with the alphabetical ordering of the keywords, enables the keyword comparer 27 to determine rapidly whether the first four (or more) characters of any keywords stored in the data file match the received character string (step S14). If the answer at step S14 is yes, then, at step S15, the keyword comparer 27 posts a messages to the user alerter 31 (FIG. 3). Then, or if the answer at step S14 is no, the keyword comparer 27 returns to step S12.

FIG. 10 shows steps carried out by the user alerter 31. Thus, at step S20, the user alerter 31 waits for a message from the keyword comparer 27 (step S15 in FIG. 9) signalling that a keyword has been identified in the keystrokes input by the user.

When the answer at step S20 is yes, then at step S21 the user alerter 31 determines from the data file 28 (see FIG. 6) which of the alert buttons 53a to 53c is associated with the keyword and at step S22 causes the icon displayer 30 to activate the associated button for a predetermined time and also, in the present embodiment, to activate the loud speaker 19 to provide an audible alert. In this embodiment, an alert button 53a to 53c is activated by causing it to flash by intermittently changing its colour so that the user quickly becomes aware that an alert is being signalled. The user alerter 31 then returns to step S20 awaiting further keyword messages from the keyword comparer 27.

Generally, only a single keyword will be associated with an alert button. Figure lla shows the steps carried out when a user checks on an alert button 53a, 53b or 53c.

When the user clicks on or selects an alert button 53a to 53c at step S25, then the user selection accessor 32 determines, at step S28, the address (in this case the URL) associated with the selected keyword, launches, via the operating system 21, a conventional web browser such as Microsoft Internet Explorer or NetScape installed on the user's computer, and causes the user to be connected via the communications interface 100 to the URL associated with that keyword.

The web browser then downloads the web page for that URL.

An alert button may however be associated with a number of keywords.

FIG. 11b shows the steps carried out when a user checks on an alert button 53a, 53b or 53c when the alert button is associated with a number of identified keywords.

In this case, when the user clicks on or selects an alert button 53a to 53c at step S25, then at step S26 the icon displayer 30 causes, as shown in FIG. 12, a drop down list 70 of keywords associated with that alert button (the alert button 53a in FIG. 12) to be displayed on the display screen 40.

When, at step S27, the user clicks on or selects one of the keywords in the drop down list 70, then at step S28 the user selection accessor 32 determines at step S28, the address (in this case the URL) associated with the selected keyword, launches, via the operating system 21, a conventional web browser such as Microsoft Internet Explorer or NetScape installed on the user's computer, and causes the user to be connected via the communications interface 100 to the URL associated with that keyword.

The web browser then downloads the web page for that URL in conventional means.

As will be appreciated, an alert button 53a to 53c may be selected at any time, regardless of whether the alert button is or has recently been flashing. A user therefore need not necessarily access the information to which he is alerted immediately but may return to it at a more convenient time.

In the embodiment described above, the keyword data file used by the information alert icon 50 stored at the user's computer may be based on an initial keyword database supplied with the program instructions or software for implementing the information alert provider. On purchasing or obtaining the software the user may be given the option of selecting a keyword data file dependent upon their particular needs or interest. Thus, for example, a medical practitioner may select a medical keyword file while a financier or businessman may select a finance or business keyword data file. The subject matter filed covered by the keyword data file may be specialised so that, for example, in the medical field different keyword data files may be provided for different specialisms. As another possibility a user may obtain a keyword database separately. For example, a user may select an appropriate keyword database and download it from the service provider 3. This enables the user to change keyword databases easily to meet his or her current requirements.

In the above described embodiment, the user's computer 1 is coupled to the information providers 4 and 5 and the service provider via a network provided by the Internet. It will, however, be appreciated that the network 2 may be provided as a local or wide area (LAN or WAN) network, an Intranet network or any combination of these. In addition, at least one source of information may be located on the user's own hard disk or on a server 3 connected by a local connection to the user's computer. This is particularly advantageous for the medical profession because it enables, for example, a general practitioner to have a keyword data file for patients so that the general practitioner can be alerted to, for example, contraindications for particular medicaments as the practitioner is in the process of typing in a prescription for a patient, so reducing the possibility of the practitioner prescribing a medication that reacts adversely with another medication being taken by or an existing condition of the patient for whom he is prescribing. The present invention may also be used in, for example, an office environment so that a secretary can set up a keyword data file relating to previous correspondence so that when typing a new letter the secretary can be alerted to the existence of that previous correspondence.

Other operating systems, communications systems and database software than those mentioned above may be used. The user's computer 1 may use any operating system that allows for the use of keyboard hook procedures or like procedures that enable an application to obtain keystroke messages or other information regarding keystrokes from the operating system 21.

Although FIG. 1 shows only a single user's computer 1 it will, of course, be appreciated that more than one and possibly many user's computers may be coupled via the network 2 to the server 3 at the same time. Also, a given user's computer 1 may have access to one or more different service providers 3 and one or more different information providers. In the embodiments described above, the keyword data file is essentially static although the user may update their personal section of the keyword data file and the remaining part of the keyword data file may be updated periodically via the service provider 3 when the user's computer is coupled to the network 2 to keep the keyword data file up to date. As another possibility the keyword data file may be completely replaced each time the user's computer logs on to the service provider 3. This would enable, for example, a user to log on to different areas of a web site provided by the service provider 3 so that the user can access different keyword data files, dependent upon his particular interest at that time. For example, the service provider 3 may provide keyword data files for different medical specialisms, different technical specialisms and so on and the user may select a particular keyword data file by clicking on a corresponding icon on the service provider's web page.

The button 51 may be used to alert a user to incoming information provided by the service provider 3. Thus, for example, the service provider 3 may download to the user's computer via the communication interface 100, a file containing a URL for a web page having information that may be of interest to the user together with instructions for causing a corresponding the button 51 to change, for example to flash. When such information is received from the communications interface 100 via the operating system 21 by the information receiver 33 of the information alerter 23, the information receiver 33 causes the icon displayer 50 to cause the button 51 to change in accordance with instructions received in the downloaded file. This downloaded file may also include instructions as to the time or date at which the button is to be activated. When the user clicks on the button 51, then the user will be connected to the associated URL so that they can view the corresponding geb page and may download information. This enables, for example, the service provider 3 acting on behalf of an information provider 4 or 5, to alert a user to information about new products and new processes available from a commercial information provider or new academic papers or technical reports from an academic information provider. The service provider 3 may also provide the user with news updates in their fields of interest, for example, medical news for a general practitioner.

As another possibility, where the user is registered with the service provider at the service provider 3 so that the service provider holds, securely, user details including the user's email, then, when the user clicks on the downloaded alert, an email may automatically be generated to alert the information provider associated with the activation of the button 51 to the fact that the user is interested in receiving further information. This enables, for example, detailed information to be provided to the user on request after they have been alerted to its existence by the button 51. The alert button icon 50 may also enable a user to be connected to a web browser specifically tailored to provide the user with information from the service provider 3 and information providers 4 and 5 registered with the server enabling the user to be access information specifically targeted to the user's interest.

The drop down arrow 52 when selected by the user presents the user with, in this example, a drop down list of movies or videos that the user can play using the movie playing facilities generally available with Microsoft Windows. The movies or videos may be downloaded with the information alerter application from the service provider 3 and may consist of advertisements, for example drugs advertisements for the healthcare profession or training or information videos.

In the above described embodiments, three alert buttons 53a to 53c are provided. It will, of course, be appreciated that the number of alert buttons may be changed and that it is possible that only a single alert button 53 may be provided to alert the user to any relevant information. It may also be possible for a single alert button to be caused to flash different colours in accordance with the type of received information and in this case, a single button could replace the buttons 50 and 53a to 53c.

In the above described embodiments a button changes by flashing. Other ways of changing a button may be used, for example, a picture or text message may be displayed to the user to alert them to the presence of information.

Although the alerting of the user to an information provider that is unrelated to the user's actions is a useful feature, this may be omitted that is one or both of the button 51 and the drop down arrow 52 may be omitted. Where the button 51 is omitted, it may be replaced by a convention title bar.

In the above described embodiments, user information input via the keyboard is passed to the keystroke receiver 26 using a keyboard hook procedure. This provides a particularly fast and efficient way of determining the keystrokes input by a user. There are, however, other ways of determining the keystrokes input by a user. Thus, for example, the electrical signals supplied by the keyboard to the processor may be independently monitored via a serial connection and information regarding the keystrokes derived from those electrical signals and then passed to the keyboard receiver 26. As another possibility, the computer 1 may be coupled to a digital camera that enables images of the keyboard to be obtained and imaging software may then be used to process these images to determine the location on the keyboard of the user's fingers and thus the keystrokes effected by the user. This would, however, be much slower than using the keyboard hook which has the advantage that the entire process of determining the keystroke and identifying keywords can be effected in a time which is short compared with usual typing speeds so that the process of identifying keywords does not interfere with the input of information by the user.

In the above described embodiments, the user input is via the keyboard. Where the user's computer 1 is provided with speech recognition software then the user may input information using the microphone 20 shown in FIG. 2. In this case, the keyboard receiver 26 will receive identified words or phonemes from the speech recognition software which it will then pass on to the keyword comparer 27 for comparison in the manner described above.

In the above described embodiments, the user's computer 1 is a personal computer operating under the Microsoft Windows operating system. As mentioned above, other operating systems such as Linux or Unix may be used. Also, the user's computer may be a portable computer or a palmtop operating under the Windows CE operating system. In addition, the present invention may also be implemented on a WAP mobile telephone.

In the above described embodiments, the keyword comparer identifies exact matches. Generally, the exact match will be for part of a word although it could be for a whole word. The keyword data file may also be constructed to enable the keyword comparer to identify synonyms and to identify words having the same stem.

1. Apparatus for alerting a user to the existence of information, comprising:
receiving means for receiving input information supplied by a user;
comparing means for comparing information supplied by the user with information stored in storing means; and alerting means for alerting a user when the comparing means determines that information related to information received by the receiving means is stored by the storing means.

2. Apparatus according to claim 1, wherein the receiving means is arranged to receive the input information as information relating to words supplied by the user.

3. Apparatus according to claim 1, wherein the receiving means comprises a keystroke receiver for receiving input information supplied by a user as keystroke information representing keystrokes made by a user on a keyboard.

4. Apparatus according to claim 3, wherein the keystroke receiver comprises a keyboard hook for obtaining keystroke information as keystroke messages from a computer operating system.

5. Apparatus according to claim 1, wherein the receiving means is arranged to filter out or ignore input information that does not represent or relate to a character for forming a word.

6. Apparatus according to claim 1, wherein the receiving means is arranged to store information relating to received input information.

7. Apparatus according to claim 1, wherein the receiving means is arranged to store information relating to received input information and to pass stored information to the comparing means when information relating to at least a predetermined number of characters has been stored.

8. Apparatus according to claim 6, wherein the receiving means is arranged to add received information to already stored information when the received information relates to or represents a character for forming a word.

9. Apparatus according to claim 6, wherein the receiving means is arranged to delete all stored information in response to receipt of input information representing or relating to the start of a new word.

10. Apparatus according to claim 6, wherein the receiving means is arranged to delete the last stored information in response to receipt of input information representing or relating to deletion of a character.

11. Apparatus according to claim 1, wherein the comparing means is arranged to compare information supplied by the user with keywords stored in the storing means.

12. Apparatus according to claim 1, wherein the alerting means is arranged to provide at least one of an audible and a visual alert to a user.

13. Apparatus according to claim 1, wherein the alerting means is arranged to provide a visual alert by causing a portion of a display screen to change, for example to flash or change colour.

14. Apparatus comprising processor means programmed by program instructions to provide apparatus in accordance with claim 1.

15. Apparatus according to claim 14, wherein the processor means has access to applications software and the receiving means is arranged to receive information input by the user to an application being implemented by the processor means.

16. Apparatus according to claim 1, further comprising a user interface having input means for enabling a user to input information and output means for supplying information to a user.

17. Apparatus according to claim 16, wherein the input means comprises a keyboard and the output means comprises a display.

18. Apparatus according to claim 1, further comprising coupling means for enabling a user to be coupled to a source of further information over a network when the comparing means determines that information related to information received by the receiving means is stored by the storing means.

19. Information processing apparatus, comprising a user interface comprising a keyboard for enabling a user to input information, a display for displaying information to the user, a data store for storing keywords and a processor having associated memory, the processor being configured by program instructions to provide an information alerter for alerting a user to the existence of information, comprising:
an icon displayer for displaying an information alerter icon on top of an applications window displayed on the display;
a keystroke receiver for receiving keystroke information relating to keystrokes made by the user to input information into an applications window displayed by the display;
a keyword comparer for comparing keywords stored in the data store with keystroke information received by the keystroke receiver; and
a user alerter for causing at least a part of the alerter icon to change when the keyword comparer identifies at least one keyword corresponding to information input to an application as keystrokes by the user.

20. Apparatus according to claim 19, wherein the user alerter is arranged to cause at least a part of the alerter icon to change colour or to flash.

21. Apparatus according to claim 19, further comprising a selector and a coupler for coupling the user to a source of information related to a keyword identified by the keyword comparer when a user selects said at least part of the icon using the selector.

22. Apparatus according to claim 21, wherein said icon displayer is arranged to display a drop down list consisting of the identified keyword or keywords when a user selects said at least part of the icon using the selector.

23. Apparatus according to claim 22, wherein the coupler is arranged to couple the apparatus to a source of information when the user selects a keyword from the drop down list using the selector.

24. Apparatus according to claim 21, wherein the coupler is arranged to couple the apparatus to a computer providing a source of information over a network.

25. Apparatus according to claim 19, wherein the keystroke receiver comprises a keyboard hook for obtaining keystroke information as keystroke messages from an operating system of the processor.

26. Apparatus according to claim 19, wherein the keystroke receiver is arranged to filter out or ignore any keystroke that does not represent or relate to a character for forming a word.

27. Apparatus according to claim 19, wherein the keystroke receiver is arranged to store information relating to received keystrokes.

28. Apparatus according to claim 19, wherein the keystroke receiver is arranged to store information relating to received keystrokes and to pass stored keystroke information to the keyword comparer means when information relating to at least a predetermined number of keystrokes has been stored.

29. Apparatus according to claim 27, wherein the keystroke receiver is arranged to add received keystroke information to already stored keystroke information when the received information relates to or represents a character for forming a word.

30. Apparatus according to claim 27, wherein the keystroke receiver is arranged to delete all stored keystroke information in response to receipt of keystroke information representing activation of a key such as the spacebar, full stop or other punctuation mark key representing or relating to the start of a new word.

31. Apparatus according to claim 27, wherein the keystroke receiver is arranged to delete the last stored keystroke information in response to receipt of keystroke information representing activation of a key such as a backspace key relating to deletion of a character.

32. Apparatus according to claim 19, wherein the user alerter is arranged to provide an audible alert to a user.

33. Apparatus according to claim 19, further comprising an information receiver for receiving information from an information provider, wherein the user alerter is arranged to cause a part of the alerter icon to change to alert a user to incoming information from an information provider unrelated to information supplied by the user.

34. Apparatus according to claim 19, wherein the icon displayer is arranged to display as the information alerter icon an icon having different buttons for alerting a user to different types of information corresponding to identified keywords and the user alerter is arranged to cause the button associated with a particular type of information to change when a keyword associated with that type of information is identified.

35. Apparatus according to claim 19, wherein the icon displayer is arranged to display as the information alerter icon an icon having a button for alerting a user to information corresponding to an identified keyword and the user alerter is arranged to cause the button to change when a keyword is identified and wherein an information receiver is provided for receiving information from an information provider and the user alerter is arranged to cause another button of the alerter icon to change to alert a user to incoming information from an information provider unrelated to information supplied by the user.

36. Apparatus according to claim 19, wherein an information receiver is provided for receiving information from an information provider and the icon displayer is arranged to display as the information alerter icon an icon having a drop down menu arranged to display video information received by the information receiver.

37. Apparatus for providing a user interface, comprising: display causing means for causing an information alert to be displayed on a display in response to a user supplying information corresponding to stored information.

38. Apparatus according to claim 37, wherein the display causing means comprises first means for causing an information alert region to be displayed on the display and second means for causing at least a part of the information alert region to change in response to a user supplying information corresponding to stored information.

39. Apparatus according to claim 38, wherein the second means is arranged to cause different parts of the alerter region to change dependent on type information associated with the stored information.

40. Apparatus according to claim 38, wherein the second means is arranged to cause at least part of the information alerter region to change in response to receipt of information from an information provider.

41. Apparatus for providing a user interface for information processing apparatus having a keyboard for enabling a user to input information, a display for displaying the user interface, a data store for storing keywords and a processor configurable by program instructions to provide an operating system for controlling operation of the apparatus and enabling running of applications software by the processor in windows displayed on the display, the apparatus comprising:
an icon displayer for displaying an information alerter icon on top of an applications window; and a user alerter for causing at least a part of the alerter icon to change when information input to an application as keystrokes by the user corresponds to a keyword stored in the data store.

42. Apparatus according to claim 41, wherein the icon displayer is arranged to display the alerter icon as a plurality of buttons and the user alerter is arranged to cause different ones of the button to change for different types of information.

43. Apparatus according to claim 41, wherein the icon displayer is arranged to display as the information alerter icon an icon having a drop down menu arranged to display video information.

44. A method of controlling apparatus to alert a user to the existence of information, comprising the steps of: receiving input information supplied by a user; comparing information supplied by the user with information stored in storing means; and alerting a user when information related to received information is stored by the storing means.

45. A method according to claim 44, wherein the receiving step receives the input information as information relating to words supplied by the user.

46. A method according to claim 44, wherein the receiving step receives input information supplied by a user as keystroke information representing keystrokes made by a user on a keyboard.

47. A method according to claim 46, wherein the receiving step obtains keystroke information as keystroke messages from a computer operating system.

48. A method according to claim 44, wherein the receiving step filters out or ignores input information that does not represent or relate to a character for forming a word.

49. A method according to claim 44, wherein the receiving step stores information relating to received input information.

50. A method according to claim 44, wherein the receiving step stores information relating to received input information and passes stored information for comparison in the comparing step when information relating to at least a predetermined number of characters has been stored.

51. A method according to claim 49, wherein the receiving step adds received information to already stored information when the received information relates to or represents a character for forming a word.

52. A method according to claim 49, wherein the receiving step deletes all stored information in response to receipt of input information representing or relating to the start of a new word.

53. A method according to claim 49, wherein the receiving step deletes the last stored information in response to receipt of input information representing or relating to deletion of a character.

54. A method according to claim 44, wherein the comparing step compares information supplied by the user with keywords stored in the storing means.

55. A method according to claim 44, wherein the alerting step provides at least one of an audible and a visual alert to a user.

56. A method according to claim 44, wherein the alerting step provides a visual alert by causing a portion of a display screen to change, for example to flash or change colour.

57. A method comprising programming processor means using program instructions to carry out a method in accordance with claim 44.

58. A method according to claim 57, which comprises providing the processor means with access to applications software and wherein the receiving step receives information input by the user to an application being implemented by the processor means.

59. A method according to claim 44, further comprising coupling a user to a source of further information over a network when information related to information received by the receiving means is stored by the storing means.

60. A method of operating an information processing apparatus comprising a user interface comprising a keyboard for enabling a user to input information, a display for displaying information to the user, a data store for storing keywords and a processor having associated memory, the method comprising causing the processor to carry out the steps of:
displaying an information alerter icon on top of an applications window displayed on the display;
receiving keystroke information relating to keystrokes made by the user to input information into an applications window displayed by the display;
comparing keywords stored in the data store with keystroke information received by the keystroke receiver to identify any keyword related to the received keystroke information; and
alerting a user by causing at least a part of the alerter icon to change when received keystroke information corresponds to a stored keyword.

61. A method according to claim 60, wherein the user alerting step causes at least a part of the alerter icon to change colour or to flash.

62. A method according to claim 60, further comprising the step of coupling the user to a source of information related to an identified keyword when a user selects said at least part of the icon.

63. A method according to claim 62, which comprises the further step of displaying a drop down list consisting of the identified keyword or keywords when a user selects said at least part of the icon.

64. A method according to claim 63, wherein the coupling step couples to a source of information when the user selects a keyword from the drop down list.

65. A method according to claim 62, wherein the coupling step couples to a computer providing a source of information over a network.

66. A method according to claim 60, wherein the receiving step obtains keystroke information as keystroke messages from an operating system of the processor.

67. A method according to claim 60, wherein the receiving step filters out or ignores any keystroke that does not represent or relate to a character for forming a word.

68. A method according to claim 60, wherein the receiving step stores information relating to received keystrokes.

69. A method according to claim 60, wherein the receiving step stores information relating to received keystrokes and passes stored keystroke information on for comparison in the comparing step when information relating to at least a predetermined number of keystrokes has been stored.

70. A method according to claim 68, wherein the receiving step adds received keystroke information to already stored keystroke information when the received information relates to or represents a character for forming a word.

71. A method according to claim 68, wherein the receiving step deletes all stored keystroke information in response to receipt of keystroke information representing activation of a key such as the spacebar, full stop or other punctuation mark key representing or relating to the start of a new word.

72. A method according to claim 68, wherein the receiving step deletes the last stored keystroke information in response to receipt of keystroke information representing activation of a key such as a backspace key relating to deletion of a character.

73. A method according to claim 60, wherein the user alerting step provides an audible alert to a user.

74. A method according to claim 60, further comprising a step of receiving information from an information provider, wherein the user alerting step causes a part of the alerter icon to change to alert a user to incoming information from an information provider unrelated to information supplied by the user.

75. A method according to claim 60, wherein the icon displaying step displays as the information alerter icon an icon having different buttons for alerting a user to different types of information corresponding to identified keywords and the user alerting step causes the button associated with a particular type of information to change when a keyword associated with that type of information is identified.

76. A method according to claim 60, wherein the icon displaying step displays as the information alerter icon an icon having a button for alerting a user to information corresponding to an identified keyword and the user alerting step causes the button to change when a keyword is identified and wherein the method further comprises a step of receiving information from an information provider and the user alerting step causes another button of the alerter icon to change to alert a user to incoming information from an information provider unrelated to information supplied by the user.

77. A method according to claim 60, further comprising the step of receiving information from an information provider and wherein the icon displaying step displays as the information alerter icon an icon having a drop down menu arranged to display video information received by the information receiver.

78. A method of providing a user interface, comprising: the step of causing an information alert to be displayed on a display in response to a user supplying information corresponding to stored information.

79. A method according to claim 37, wherein the step of causing an information alert to be displayed comprises a first step of causing an information alert region to be displayed on the display and a second step of causing at least a part of the information alert region to change in response to a user supplying information corresponding to stored information.

80. A method according to claim 79, wherein the second step causes different parts of the alerter region to change dependent on type information associated with the stored information.

81. A method according to claim 79, wherein the second step causes at least part of the information alerter region to change in response to receipt of information from an information provider.

82. A method for providing a user interface for information processing apparatus having a keyboard for enabling a user to input information, a display for displaying the user interface, a data store for storing keywords and a processor, the method comprising causing the processor to carry out the steps of:
displaying an information alerter icon on top of an applications window displayed on the display; and
alerting a user by causing at least a part of the alerter icon to change when information input to an application as keystrokes by the user corresponds to a keyword stored in the data store.

83. A method according to claim 82, wherein the icon displaying step displays the alerter icon as a plurality of buttons and the user alerting step causes different ones of the button to change for different types of information.

84. A method according to claim 82, wherein the icon displaying step displays as the information alerter icon an icon having a drop down menu arranged to display video information.

85. A signal carrying program instructions or code for causing a processor to carry out a method in accordance with claim 44.

86. A storage medium carrying program instructions or code for causing a processor to carry out a method in accordance with claim 44.
